(19) United States
(12) Patent Application Publication
(10) Pub. No.: US 2019/0277973 A1
(43) Pub. Date: Sep. 12, 2019

(54) Evaluation Unit, System for a Vehicle Comprising an Evaluation Unit, and Method for Determining a Position of a Vehicle in a Satellite-Aided Manner

(71) Applicant: Robert Bosch GmbH, Stuttgart (DE)

(72) Inventor: Marlon Ramon Ewert, Untergruppenbach (DE)

(21) Appl. No.: 16/294,678

(22) Filed: Mar. 6, 2019

(30) Foreign Application Priority Data
Mar. 7, 2018 (DE) 10 2018 203 346.3

(51) Int. Cl. G01S 19/09

(52) U.S. Cl. CPC G01S 19/09

(57) ABSTRACT

A Global Navigation Satellite System (GNSS) evaluation unit for a vehicle is configured to receive data from a plurality of receiving units via a single interface, and determine a positon of the vehicle with reference to GNSS data. Each of the receiving units is configured to receive GNSS data. A system for a vehicle includes such a GNSS evaluation unit and a plurality of such receiving units. A method for determining a position of a vehicle in a satellite-aided manner includes operating such a system.

This application claims priority under 35 U.S.C. § 119 to patent application no. DE 10 2018 203 346.3, filed on Mar. 7, 2018 in Germany, the disclosure of which is incorporated herein by reference in its entirety.

The disclosure relates to a Global Navigation Satellite System (GNSS) evaluation unit, a system for a vehicle comprising a corresponding evaluation unit, and a method for determining a position of a vehicle in a satellite-aided manner. The disclosure is suitable, in particular, for application in autonomous driving.

### BACKGROUND

An autonomous vehicle is a vehicle that manages without a driver. In this case, the vehicle drives autonomously by for example independently recognizing the course of the road, other road users or obstacles and calculating the corresponding control commands in the vehicle and forwarding them to the actuators in the vehicle, as a result of which the trajectory of the vehicle is influenced correctly. The driver does not participate in the driving process in the case of a fully autonomous vehicle.

Currently available vehicles are not yet able to act autonomously. Firstly because the corresponding technology is not yet fully mature. Secondly because, at present, it is still a legal stipulation that the vehicle driver himself/herself must be able to intervene in the driving process at any time. This hampers the implementation of autonomous vehicles. However, there are already systems from various manufacturers which realize autonomous or partly autonomous driving. These systems are in the intensive test phase. It is already foreseeable at the present time that in a few years fully autonomous vehicle systems will come to market as soon as the hurdles mentioned above have been cleared out of the way.

For autonomous operation a vehicle requires, inter alia, a sensor system that is able to determine a highly accurate vehicle position, in particular with the aid of navigation satellite data (GPS, GLONASS, Beidou, Galileo). For this purpose, at present GNSS (Global Navigation Satellite System) signals and in addition GNSS correction data are received via a GNSS antenna on the vehicle roof and transferred via a cable connection for example into a GNSS sensor. However, this has various disadvantages.

With the use of more than one GNSS antenna in the vehicle, for improved reception of satellite correction data, for example, the entire GNSS sensor has to be adapted in terms of hardware and software, such that said sensor is able also to read in and process the signals of a second and/or further antenna. In this case, on account of the individual cabling, the number of antenna connectors at the sensor increases in accordance with the number of antennas present, which significantly increases the structural space of the sensor.

Moreover, the integration complexity of the system is increased. The tiniest change in the radio-frequency path between GNSS antenna and GNSS sensor (cable length) generally necessitates adaptations in the sensor hardware since signal reflections can occur on the antenna cable or in the receiver circuit of the GNSS sensor given incorrect system design, thereby adversely affecting the recognition quality of GNSS satellite data in the receiver circuit. This is disadvantageous primarily if the GNSS sensor is intended to be integrated into different vehicles, which generally have different antennas and antenna positions in the vehicle, such that in particular the cable length(s) differ(s) from vehicle to vehicle.

To compound matters, the antenna signals have to be amplified before they can be forwarded to the GNSS sensor via the radio-frequency cable line. The cable length plays an important part in this case as well. The current required for this originates from the sensor itself or from the vehicle.

### SUMMARY

What is proposed here is an evaluation unit for a vehicle, configured for determining a position on the basis of GNSS data, wherein the evaluation unit is configured to receive data from a multiplicity of receiving units, each configured for receiving GNSS data, via a single interface.

GNSS stands for Global Navigation Satellite System. GNSS is a system for position determination and/or navigation on the ground and/or in the air by means of the reception of the signals from navigation satellites, referred to here as satellite data. In this case, GNSS is a collective term for the use of existing and future global satellite systems, such as GPS (NAVSTRAR GPS), GLONASS, Beidou and Galileo. Thus, a GNSS sensor is a sensor system suitable for receiving and processing, for instance evaluating, navigation satellite data. Preferably, the GNSS sensor is able to determine a highly accurate vehicle position with the aid of navigation satellite data (GPS, GLONASS, Beidou, Galileo). GNSS data are, in particular, data received from a navigation satellite; GNSS data can also be referred to as “navigation satellite data”.

The evaluation unit can, for example, be configured in the manner of a GNSS sensor or in the manner of a position and motion sensor or be part of such a sensor. Corresponding GNSS or position and motion sensors are required for automated driving and calculate a highly accurate vehicle position with the aid of navigation satellite data (GPS, GLONASS, Beidou, Galileo), which are also referred to as GNSS (Global Navigation Satellite System) data. Furthermore, correction data can be concomitantly used by so-called correction services in the sensor in order to calculate the position of the vehicle even more accurately. Together with the received GNSS data, in the sensor a highly accurate time (such as universal time) is regularly also read in and used for the accurate position determination. Further input data in the position sensor can be wheel rotational speeds, steering angles, and also acceleration and rate-of-rotation data.

The evaluation unit can have diverse or a multiplicity of (different) interfaces and/or connections. It is provided here, however, that the evaluation unit can receive data from a multiplicity of (GNSS) receiving units or GNSS antennas via a single interface. In other words, this means, in particular, that only one interface is present for the communication with a multiplicity of (GNSS) receiving units or even for the communication with all receiving units (GNSS antennas) which are arranged in or on the vehicle and/or are available in the environment of the vehicle.

The receiving units are each provided and configured for receiving navigation satellite data. In the simplest case, a receiving unit is constructed in the manner of a GNSS antenna. Furthermore, the receiving unit regularly has means for providing or for forwarding or sending the (previously) received GNSS data.

It is particularly advantageous if the interface is configured for wireless reception.

The interface particularly preferably comprises a WLAN or Bluetooth module configured to receive data from receiving units. The receiving units preferably likewise have interfaces comprising WLAN or Bluetooth modules. The communication between the evaluation unit and the receiving units thus preferably functions using WLAN or Bluetooth. It is possible to use any other protocol for carrying out the communication. However, wireless communication or radio communication is preferably involved.

According to a further aspect, a system for a vehicle is also proposed, comprising:
an evaluation unit, configured for determining a position of the vehicle on the basis of GNSS data, as has already been described above,
at least one receiving unit, configured for receiving GNSS data,
wherein the evaluation unit is configured to receive GNSS data from the at least one receiving unit via the interface.

The system is particularly preferably a combination of system components (evaluation unit and receiving unit). The system components of the system can be built into a motor vehicle in order to equip the motor vehicle with the system. The system components are preferably set up in relation to one another. That is to say, for example, that the evaluation unit and the at least one receiving unit are set up in advance to communicate with one another. The vehicle can be an automobile. The vehicle is preferably an autonomous vehicle. The evaluation unit is preferably located in the vehicle. With further preference, the at least one receiving unit is configured to be arranged in the vehicle or is already arranged in the vehicle.

The interface is (as already described further above) preferably a wireless interface or a radio interface. The use of a wireless interface or a radio interface has proved to be particularly advantageous since, firstly, this contributes to making it possible for complex individual cabling to be obviated, and secondly cabling-specific signal impairments such as, for instance, reflections in long radio-frequency antenna cables can be avoided, which is especially advantageous for the quality of the GNSS data arriving in the evaluation unit. Furthermore, a wireless interface or a radio interface enables the simplified integration of the evaluation unit into different vehicles and of the receiving unit at different positions in or on the vehicle. Moreover, the wireless interface or the radio interface also allows recourse to receiving units which do not belong to the vehicle, for instance are positioned in a stationary fashion at the edge of the road or are carried along in neighboring vehicles. Such receiving units can be treated by the described evaluation unit in a vehicle (almost) like receiving units which are arranged in or on the motor vehicle and (if appropriate) are fixedly connected to the motor vehicle.

In a further embodiment, the GNSS data are transmitted from the receiving unit or from the receiving units to the evaluation unit via a conventional vehicle BUS (e.g. ethernet). In this case, both the receiving units and the evaluation unit are advantageously connected to one another via a BUS connection. In other words, the single interface can be realized by a BUS interface. The BUS connection is preferably realized on the wireless interface described. In this case, the BUS connection describes for example a communication protocol according to which the evaluation unit and the receiving units communicate on the BUS. The receiving unit must generally have such a (standardized) interface in order to be able to communicate with other components in the vehicle, for instance an on-board computer and/or a navigation system. It is particularly advantageous in this case that in general only a software adaptation would be necessary in order to be able to receive GNSS data via the BUS interface, such that no significant hardware interventions would be necessary in order to use the BUS interface as a single interface.

According to one advantageous configuration, it is proposed that the system comprises at least two receiving units, wherein the receiving units are arranged at a distance from one another. Preferably, one of the receiving units is arranged at the front of the vehicle and one of the receiving units at the back of the vehicle, or is provided for an arrangement at the front of the vehicle and at the back of the vehicle.

According to one advantageous configuration, it is proposed that a first receiving unit of the at least two receiving units is a first GNSS antenna and a second receiving unit of the at least two receiving units is a second GNSS antenna, wherein the second GNSS antenna is constructed in a simplified fashion in comparison with the first GNSS antenna.

Particularly preferably, at least one receiving unit consists of a so-called low-cost GNSS antenna. The data of this receiving unit can be used in the evaluation unit for filtering out multi-path effects and/or for plausibilizing further GNSS data. It is furthermore preferred if a plurality of low-cost receiving units are arranged on the vehicle. In particular, such a plurality of low-cost receiving units are arranged around an interior of the vehicle. All these low-cost receiving units are connected to the evaluation unit in each case via radio. The cabling outlay in the vehicle decreases further here as a result of the wireless data transfer. Moreover, a very good receivability of GNSS signals can be achieved. This is also owing to the fact, in particular, that the vehicle itself in the case of such an arrangement does not constitute a cover at least for individual receiving units from among those arranged around the interior of the vehicle.

According to a further aspect, a method for determining a position of a vehicle on the basis of GNSS data is also proposed, comprising the following steps:
a) receiving GNSS data by means of at least one, preferably at least two, receiving unit(s),
b) transferring GNSS data from the receiving unit to an evaluation unit via an interface via which a multiplicity of receiving units can communicate with the evaluation unit, and
c) evaluating GNSS data by means of the evaluation unit in order to determine the position.

The indicated order of steps a) to c) is merely by way of example. Of course, some or all of the steps can also be implemented at the same time or at least partly in parallel. Moreover, the order of steps b) and c) can also be reversed in a regular operational sequence.

In step a), navigation satellite data are received by means of at least one receiving unit. Preferably, the navigation satellite data are received by means of at least two receiving units. Preferably, at least one receiving unit or one of said receiving units is arranged in or on the vehicle. Each receiving unit generally has a GNSS antenna. At least the receiving unit arranged in or on the vehicle is preferably supplied with power from the vehicle or via an on-board electrical system of the vehicle. Moreover, in one preferred configuration, the receiving unit has a wireless interface or a radio interface. This allows the receiving unit to transfer received GNSS signals wirelessly. In addition, the receiving unit can have a processing unit that converts the received GNSS signals or navigation satellite data into a uniform data format before the wireless transfer. The processing unit can also carry out processing steps for determining the position from the raw data originally received by the receiving unit. The signals which are provided by the receiving unit and are received by the evaluation unit are then no longer raw data, but rather position data or raw position data already calculated from said raw data. In this case, the GNSS signals can already be preamplified and/or filtered. In this case, filtering can be understood to mean the separation of L1 and/or L2 and/or L-band signals and/or further signals from a carrier frequency. Alternatively or cumulatively, it is possible for the GNSS data already to be correlated in the receiver unit. A wireless transfer of the then advantageously uniform GNSS data or preprocessed data or position data or raw position data in the vehicle can then be carried out.

In step b), GNSS data are transferred from the receiving unit to an evaluation unit arranged in or on the vehicle. In general, in this case the navigation satellite data previously received by the receiving unit are made available to the evaluation unit as GNSS data. In this case, in the receiving unit, for the purpose of generating the GNSS data, a processing of the navigation satellite data, for instance a filtering, standardization and/or correlation, can be carried out, as has been explained in greater detail above. The transfer is carried out via a (shared and/or single) interface (of the evaluation unit) via which a multiplicity of receiving units can communicate with the evaluation unit. In other words, this means, in particular, that the data pass through the same (single) interface (of the evaluation unit) on their way from the respective receiving unit(s) to the evaluation unit.

In step c), GNSS data are evaluated by means of an evaluation unit arranged in or on the vehicle. In particular, the data are then processed further in at least one evaluation unit of the vehicle. The evaluation unit can be for example a GNSS sensor or a (vehicle) position and motion sensor, which calculates a highly accurate vehicle position and/or vehicle motion from the GNSS data. Alternatively, the evaluation unit can be part of such a sensor. It is also possible for the evaluation unit itself also to comprise a receiving unit and for the evaluation unit nevertheless to comprise an interface via which the evaluation unit can receive GNSS data from further receiving units. With further preference, the evaluation unit is a control device (so-called MAP control device), which determines a vehicle position on a map, or the evaluation unit is part of such a control device. For this purpose, the received GNSS data are preferably received via a wireless interface or a radio interface of the evaluation unit and preferably forwarded to downstream units, such as correlation units and/or microcontroller (μC). The downstream units of the evaluation unit can then process the received GNSS data in a manner as already customary nowadays.

During the operation of the motor vehicle, steps a), b) and c) preferably take place permanently in parallel or regularly repeatedly in order to enable an accurate position to be determined at any time.

According to one advantageous configuration, it is proposed that in step b) the GNSS data are transferred wirelessly from the receiving unit to the evaluation unit. Preferably, a wireless transfer of GNSS data in the vehicle is carried out in step b).

According to one advantageous configuration, it is proposed that in step b) the GNSS data are transferred from the receiving unit to the evaluation unit by means of a Vehicle-to-X communication link (referred to as: car-to-X communication), or according to this standard. Vehicle-to-Vehicle communication (referred to as: Car-to-Car communication, or for short: Car2Car or C2C) is understood to mean the exchange of information and data between (motor) vehicles. The aim of this data exchange is to report critical and hazardous situations to the driver at an early stage. The relevant vehicles collect data, such as ABS interventions, steering angles, position, direction and speed, and send this data to the other road users via radio (WLAN, UMTS, etc.). The intention here is to lengthen the “visibility range” of the driver using electronic means. Vehicle-to-Infrastructure communication (referred to as: Car-to-Infrastructure, or for short: C2I) is understood to mean the exchange of data between a vehicle and the surrounding infrastructure (e.g. traffic signals). The technologies mentioned are based on the cooperation of sensors of the different traffic partners and use the latest methods of communication technology for exchanging this information. In this case, Vehicle-to-X is a generic term for the various communication links, such as Vehicle-to-Vehicle and Vehicle-to-Infrastructure.

If the wireless transfer of the GNSS data or signals (in the vehicle) is carried out with the aid of a Car-to-X communication link, or according to this standard, it is preferred if the data transfer rate here is at least as high as the highest satellite frequency to be transmitted. By way of example, a WLAN radio link can be used in this context.

It is furthermore preferred if GNSS data, in particular correction data, are transferred (directly) to the evaluation unit by means of a Vehicle-to-X communication link (referred to as: Car-to-X communication) or according to the standard. Preferably, GNSS data are received alongside or in addition to the reception of GNSS data via a receiving unit (GNSS antenna), in particular of the ego vehicle, via a Vehicle-to-X communication link in the vehicle or by the evaluation unit. This can constitute a second path for the communication between the receiving unit and the evaluation unit. In this case, it is advantageous, however, for the second path also to run via the single or shared interface.

The interface is preferably a Vehicle-to-X communication interface. Preferably, a further receiving unit having a Vehicle-to-X communication interface toward the outside transfers GNSS data (directly) to the evaluation unit. Furthermore, GNSS data can be transferred to the evaluation unit from a neighboring vehicle or an infrastructure point, for instance an interstate highway bridge or traffic lights, in particular via a Vehicle-to-X communication. Particularly preferably, the neighboring vehicle or the infrastructure point comprises the receiving unit which transfers GNSS data to the evaluation unit via the interface in step b). Alternatively, provision can be made for the neighboring vehicle or the infrastructure point to comprise a further receiving unit which transfers GNSS data to the evaluation unit via the interface. In this case, the receiving unit advantageously comprises a Vehicle-to-X communication interface toward the outside. If GNSS data are already present in the Vehicle-to-X format, it is advantageous to transfer them directly via the (uniform) interface to the evaluation unit, which in this case is advantageously embodied as a Vehicle-to-X communication interface.

With further preference, the wireless transfer of the GNSS data (in the vehicle) is carried out in an encrypted form. The receiving unit or transmitting unit (of the receiving unit) particularly preferably has a dedicated identifier, in particular MAC address, which enables the interfaces to be uniquely identified among one another.

According to one advantageous configuration, it is proposed that the GNSS data are processed in the receiving unit in such a way that the GNSS data comprise information about the receiving unit from which they were or are transferred to the evaluation unit. Preferably, here via a wireless interface or a radio interface of the evaluation unit, the GNSS data of a plurality of receiving units, in particular GNSS antennas in or on the vehicle, are received and processed further in the evaluation unit. In this case, it is particularly advantageous if the GNSS data contain a unique identifier (antenna ID).

Preferably, the data from (at least) two GNSS antennas situated at different positions in or on the vehicle are received via a wireless interface or a radio interface of the evaluation unit. In the evaluation unit, the data can subsequently be fused or be evaluated in different paths. By way of example, one GNSS antenna can be situated at the front of the vehicle, and one GNSS antenna at the back of the vehicle. Depending on satellite constellation, direction of travel and surrounding structures, the GNSS reception may be better in one of the antennas than in the further antenna. Transferring both antenna data to the evaluation unit makes it possible to carry out an improved vehicle position determination. It is furthermore preferred if one GNSS antenna receives L1/L2 signals (in an improved manner), while a further antenna receives only L-band signals (in an improved manner). In the evaluation unit, L1/L2 signals having a high quality can then be extracted from the data of the first antenna (first receiving unit), while L-band signals having a high quality can be extracted from the data of the second antenna (second receiving unit). As a result, the vehicle position determination can likewise be improved, wherein the cabling outlay turns out to be low as a result of the wireless transfer.

In a further embodiment, the receiving units are supplied with power via a shared line. The receiving units are preferably connected in a chain (series circuit) for this purpose. This can contribute to further reduction of the cabling outlay in the vehicle. In yet another embodiment, a plurality of GNSS antennas are joined together to form a receiving unit which is able to transfer the received GNSS data into the vehicle. In this case, the components can be situated in a dedicated housing.

The details, features and advantageous configurations discussed in association with the evaluation unit can correspondingly also occur for the vehicle and/or the method presented here, and vice versa. In this respect, reference is made to the entirety of the explanations there for more specific characterization of the features.

A computer program for carrying out a method described here is also intended to be described here. In other words, this concerns, in particular, a computer program (product), comprising instructions which, upon the program being executed by a computer, cause the latter to carry out a method described here or at least one part thereof (in particular step c). The evaluation unit or a computing unit (processor) of the evaluation unit accesses the computer program, for example, in order to carry out the method or at least one part thereof (in particular step c).

Furthermore, a machine-readable storage medium on which the computer program is stored is also intended to be described. The machine-readable storage medium is regularly a computer-readable data carrier. Alternatively or cumulatively, a circuit can be provided which is embodied preferably as an integrated or a discrete circuit and particularly preferably as a (digital) application-specific integrated circuit (ASIC). The circuit is configured to carry out a method described here or at least one part thereof (in particular step c) and/or to execute the computer program. For this purpose, the (digital) ASIC can have a multiplicity of correspondingly configured logic functions.

The details, features and advantageous configurations discussed in association with the method can correspondingly also occur in the computer program, the storage medium and/or circuit presented here, and vice versa. In this respect, reference is made to the entirety of the explanations there for more specific characterization of the features.

### BRIEF DESCRIPTION OF THE DRAWINGS

The solution presented here, and its technical environment, are explained in greater detail below with reference to the figures. It should be pointed out that the disclosure is not intended to be restricted by the exemplary embodiments shown. In particular, unless explicitly explained otherwise, it is also possible to extract partial aspects of the substantive matter explained in the figures and combine them with other constituent parts and/or insights from other figures and/or the present description. In the figures, schematically:

FIG. 1 shows a vehicle comprising an evaluation unit, and

FIG. 2 shows a flow diagram of the method described.

### DETAILED DESCRIPTION

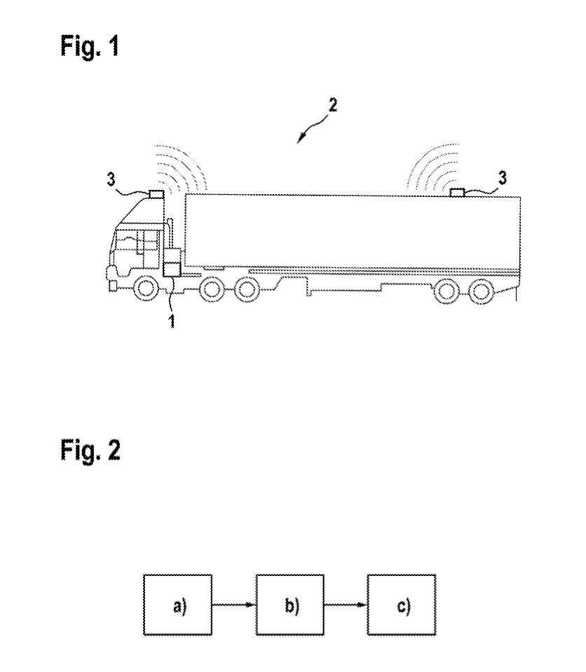

FIG. 1 schematically shows a vehicle 2. The vehicle 2 is equipped with an evaluation unit 1 equipped for determining a position of the vehicle 2 on the basis of GNSS data. For this purpose, the evaluation unit 1 can be configured for example in the manner of a GNSS sensor or in the manner of a position and motion sensor.

Furthermore, on the vehicle 2, here by way of example two receiving units 3 are fitted at a distance from one another. The receiving units 3 are each configured for receiving navigation satellite data. For this purpose, said receiving units can for example each be configured in the manner of a GNSS receiver or a GNSS antenna. Moreover, the receiving units 3 here are provided and configured for transmitting GNSS data, which is illustrated by respectively three circle arc segments in accordance with the illustration according to FIG. 1.

The evaluation unit 1 is configured to receive GNSS data from a multiplicity of receiving units 3 via a single interface. In the example according to FIG. 1, at any rate GNSS data are received from the two receiving units 3 arranged on the vehicle 2. The interface here is a wireless interface or a radio interface, which is likewise illustrated by the three circle arc segments in accordance with the illustration according to FIG. 1. The receiving units 3 transfer GNSS data wirelessly to the evaluation unit 1 via the shared wireless interface or the radio interface.

FIG. 2 shows a flow diagram of the method described here for determining a position of a vehicle. Firstly, in step a), GNSS navigation satellite data are received by at least one receiving unit. In step b), GNSS data are then transferred from the receiving unit to an evaluation unit arranged in or on the vehicle. Afterward, in step c), said GNSS data are evaluated by means of the evaluation unit.

The solution presented here contributes, in particular, to achieving one or more of the advantages mentioned below:

No or at least significantly reduced adaptation of the sensor hardware with the use of more than one GNSS antenna in the vehicle for an improved reception of satellite correction data, for example.

The structural space of the GNSS sensor can be kept small.

The integration complexity of the system in terms of hardware can be reduced since a wireless interface or a radio interface has to be enabled only once.

The cabling outlay in the vehicle can be reduced.

The quality of the GNSS data received in the evaluation unit can be increased since signal reflections on the transfer path are eliminated if there is no need to use long radio-frequency antenna cables in the vehicle.

The position determination in the evaluation unit is (thereby) increased.

The plausibilization or coarse determination of a vehicle position using GNSS data of a neighboring vehicle can result in an increase in safety in road traffic.

What is claimed is:

1. An evaluation unit for a vehicle, comprising:
a single interface configured to receive data from a plurality of receiving units, each of the receiving units configured to receive Global Navigation Satellite System (GNSS) data;
wherein the evaluation unit is configured to determine a position with reference to the GNSS data.

2. The evaluation unit of claim 1, wherein the interface is configured to receive the data wirelessly.

3. A system for a vehicle, comprising:
an evaluation unit, including a single interface configured to receive data from a plurality of receiving units that are each configured to receive Global Navigation Satellite System (GNSS) data, wherein the evaluation unit is configured to determine a position with reference to the GNSS data; and
at least one receiving unit configured to receive GNSS data, wherein the evaluation unit is configured to receive GNSS data from the at least one receiving unit via the interface.

4. The system of claim 3, wherein:
the system comprises at least two receiving units; and
the at least two receiving units are separated from each other by a distance.

5. The system of claim 4, wherein:
a first receiving unit of the at least two receiving units is a first GNSS antenna;
a second receiving unit of the at least two receiving units is a second GNSS antenna; and
the second GNSS antenna is constructed in a simplified fashion relative to the first GNSS antenna.

6. A method for determining a position with reference to Global Navigation Satellite System (GNSS) data, comprising:
receiving GNSS data via at least one receiving unit;
transferring the GNSS data from the at least one receiving unit to an evaluation unit via an interface of the evaluation unit, the interface configured to receive data from a plurality of receiving units; and
evaluating the GNSS data, via the evaluation unit, to determine the position.

7. The method of claim 6, wherein the transferring of GNSS data from the at least one receiving unit to the evaluation unit is performed wirelessly.

8. The method of claim 6, wherein the transferring of GNSS data from the at least one receiving unit to the evaluation unit is performed via a Vehicle-to-X communication link.

9. The method of claim 6, further comprising:
processing the GNSS data via the at least one receiving unit such that the GNSS data transferred from the receiving unit to the evaluation unit includes information about the at least one receiving unit from which the GNSS data was transferred.

10. The method of claim 6, wherein the method is performed by a processor executing a computer program for determining the position with reference to GNSS data.

11. The method of claim 10, wherein the computer program is stored on a machine-readable storage device.
